(19) United States
(12) Patent Application Publication
(10) Pub. No.: US 2006/0002531 A1
(43) Pub. Date: Jan. 5, 2006

(54) Telephone system in multi-function products and method and medium for operating the same

(75) Inventor: Eog-kyu Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/171,276

(22) Filed: Jul. 1, 2005

(30) Foreign Application Priority Data
Jul. 1, 2004 (KR) 2004-51004

(51) Int. Cl. H04M 11/00

(52) U.S. Cl. 379/100.01; 379/93.09

(57) ABSTRACT

A telephone system and a method and medium for operating a telephone system in a multi-function product equipped with an analog telephone circuit to realize a telephone function such that analog voice signals can be sent/received at a low price are provided. A method of operating a telephone system in a multi-function product, may include determining whether a receiver is in an off-hook state or on-hook state when a ring signal is sensed; determining whether a multi-function product is in a telephone mode or a fax mode according to whether the receiver is in the off-hook state or on-hook state; and analog processing a voice alternating current signal input from the public telephone network in a telephone circuit to output to the receiver, or digital processing a fax signal input from the public telephone network to print or store the fax signal, according to a determined mode of the multi-function product.

### CROSS-REFERENCE TO RELATED APPLICATIONS

This application claims the benefit of Korean Patent Application No. 2004-51004, filed on Jul. 1, 2004, in the Korean Intellectual Property Office, the disclosure of which is incorporated herein in its entirety by reference.

### BACKGROUND OF THE INVENTION

1. Field of the Invention

The present invention relates to a multi-function product operation system and a method and medium for operating the same, and more particularly, to a telephone system and a method and medium for operating the telephone system in a multi-function product equipped with an analog telephone circuit to realize a telephone function such that analog voice signals can be sent/received at a low price.

2. Description of the Related Art

Multi-function product (MFP) such as office automation instruments can perform a number of functions such as a telephone function, a printer function, a copier function, a scanner function, and a fax function.

FIG. 1 is a block diagram showing a configuration of an MFP, which is equipped with a conventional telephone function.

Referring to FIG. 1, the MFP includes a main portion 100, a line portion 200, a data transmission unit 300 which transmits data between the main portion 100 and the line portion 200, and a public telephone network 400.

Generally, the main portion 100 includes a central processing unit (CPU) 110, a memory 120, a modem unit 130, a line interface unit 140, a telephone control unit (analog telephone circuit) 150 which is equipped with a frequency conversion unit 151, a level conversion unit 152, and an A/D-D/A conversion unit 153, and a receiver 160.

Generally, the line portion 200 includes a line portion processing unit (IC) 210 which is equipped with a modem interface unit 211, an A/D-D/A conversion unit 212, a level conversion unit 213, a ring signal detection unit 214, an alternating current signal input unit 215, a direct current control unit 216, and an alternating current signal output unit 217, a bridge diode unit 220, and a public telephone network connection unit 230.

In the multifunction product (MFP) shown in FIG. 1, the bridge diode BD 220 of the line portion 200 always applies forward voltage to the transistors Tr1 and Tr2 even if the polarity of a switch which is connected to the public telephone network connection unit 400 is reversed. The transistor Tr1, the resistor R1, and the direct current control unit 216 allow a predetermined direct current to flow into the public telephone network connection unit 400. The transistor Tr2, a resistor R2, and the alternating current signal output unit 217 of the line portion processing unit 210 amplify the output alternating current signals to transmit the signals to the public telephone network. A capacitor C1 removes a direct current component out of alternating current signals input via the public telephone network connection unit 400 and delivers the signals to the alternating current signal input unit 215.

As described above, the line portion processing unit 210 which interacts with the public telephone network connection unit 230 which includes the transistors Tr1 and Tr2, resistors R1 and R2, and the capacitor C1 is generally called data access arrangement (DAA) unit.

Capacitors C1, C2, and C3 remove a direct current component form alternating current signals.

The data transmission unit 300 is interposed between the main portion 100 and the line portion 200, and the data transmission unit 300 transfers arranged data signals and clock signals.

The main portion 100 processes fax signals and voice signals as well known. The modem unit 130 is connected to the data transmission unit 300 via the line interface unit 140 and sends/receives fax signals and the voice signals.

When fax signals are sent/received, an output signal generated by the modem unit 130 is converted into a digital data format via the line interface unit 140 and is delivered to the modem interface unit 211 of the line portion processing unit 210 via the data transmission unit 300. The digital data is converted into a current signal via the modem interface unit 211 of the line portion processing unit 210 and is output to a base plate of the transistor Tr2 by the current signal output unit 217. The transistor Tr2 amplifies an input current signal and outputs the amplified current signal to the public telephone network 400.

When the voice alternating current signal is sent/received, first, when a ring signal is input to the MFP via the public telephone network 400, input of the ring signal is delivered to the main portion 100 via the ring signal detection unit 214. The main portion 100 recognizes the ring signal, and a contracted control command operates the direct current control unit 216 via the data transmission unit 300 to be connected to a telephone line. Next, a voice alternating current signal input to the public telephone network 400 is input to the alternating current input unit 215. The input alternating current signal is converted into a digital signal via the A/D-D/A conversion unit 212 and is transmitted to the main portion 100 via the data transmission unit 300. In the main portion 100, a digital signal transmitted in a predetermined form is restored to retrieve the voice digital signal, the voice digital signal is delivered to the telephone control unit 150, the voice digital signal is converted into the voice alternating current signal via the A/D-D/A conversion unit 153, and the voice alternating current signal is delivered to the receiver 160 such that a user can hear the voice signal of a person on the other end of the line. When a voice alternating current signal is transmitted from the receiver 160 of the MFP to the public telephone network 400, the process is reversed.

In the line portion 200, and more particularly, in an MFP having telephone function using the line portion processing unit 210, the telephone function uses the telephone control unit 150 of the main portion 100. When the telephone control unit 150 is used, an analog voice signal received from the public telephone network 400 has to be converted into a digital signal. Therefore, a voice signal heard by a user is not natural. To solve this problem, a conversion circuit having better efficiency is needed, and thus, the price of the telephone control unit 150 is increased.

### SUMMARY OF THE INVENTION

Additional aspects, features, and/or advantages of the invention will be set forth in part in the description which follows and, in part, will be obvious from the description, or may be learned by practice of the invention.

The present invention provides a telephone system of a multi-function product and a method and medium for operating the telephone system in which analog voice signals can be sent/received at a low price.

According to an aspect of the present invention, there is provided a telephone system in a multi-function product, the system including: a signal processing unit which receives ring signals, voice alternating current signals, and fax signals input from a public telephone network, digitally processes the received fax signals according to a control signal, transmits the received voice alternating current signal to a receiver, converts a fax signal to be sent into analog form, and transmits a voice alternating current signal to the public telephone network; a telephone circuit which amplifies and signal processes the switched voice alternating current signal and then outputs the switched voice alternating current signal to a receiver or signal processes a voice signal input to the receiver and then outputs the voice signal to the signal processing unit; and a control unit which determines whether the telephone system is in a telephone mode or a fax mode according to whether a receiver is on or off the hook and outputs a control signal to output the switched voice alternating current signal to the telephone circuit or a control signal to print and store the switched fax signal.

The system may further include a first data transmission unit that sends/receives digital fax data between the signal processing unit and the control unit, and a second data transmission unit that sends/receives a voice alternating current signal between the signal processing unit and the telephone circuit.

When the receiver is in an off-hook state, the multi-function product may be determined to be in a telephone mode and the control unit outputs a control signal to output the switched voice alternating current signal to the telephone circuit, and when the receiver is in an on-hook state, the multi-function product may be determined to be in a fax mode and the control unit outputs a control signal to print and store the signal processed fax signal.

According to another aspect of the present invention, there is provided a method of operating a telephone system in a multi-function product, including the operations of: (a) determining whether a receiver is in an off-hook or on-hook state when a ring signal is sensed; (b) determining whether a multi-function product is in a telephone mode or a fax mode according to whether the receiver is in the off-hook or on-hook state; and (c) analog processing a voice alternating current signal input from the public telephone network in a telephone circuit and then outputting the analog processed voice alternating convert signal to the receiver, or digital processing a fax signal input from the public telephone network to print or store the fax signal, according to the determined mode of the multi-function product.

When the receiver is in the off-hook state, the voice alternating current signal may be analog processed and then output to the receiver after determining the multi-function product is in a telephone mode, and when the receiver is in the on-hook state, the digital processed fax signal may be printed or stored after determining the multi-function product is in a fax mode.

According to another aspect of the present invention, there is provided at least one computer readable medium for storing instructions that control at least one processor which executes a method of operating a telephone system in a multi-function product, the method including determining whether a receiver is in an off-hook or on-hook state when a ring signal is sensed; determining whether a multi-function product is in a telephone mode or a fax mode according to whether the receiver is in the off-hook or on-hook state; and analog processing a voice alternating current signal input from the public telephone network in a telephone circuit and then outputting the analog processed voice alternating convert signal to the receiver, or digital processing a fax signal input from the public telephone network to print or store the fax signal, according to the determined mode of the multi-function product.

### BRIEF DESCRIPTION OF THE DRAWINGS

These and/or other aspects, features, and advantages of the present invention will become apparent and more readily appreciated from the following description of the exemplary embodiments, taken in conjunction with the accompanying drawings of which:

FIG. 1 is a block diagram showing a configuration of a multi-function product (MFP) which is equipped with a conventional telephone function;

FIG. 2 is a block diagram showing a configuration of a telephone system of an MFP, according to an exemplary embodiment of the present invention; and

FIG. 3 is a flow chart showing a method of operation of the telephone system of an MFP, according to an exemplary embodiment of the present invention.

### DETAILED DESCRIPTION OF THE PREFERRED EMBODIMENTS

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

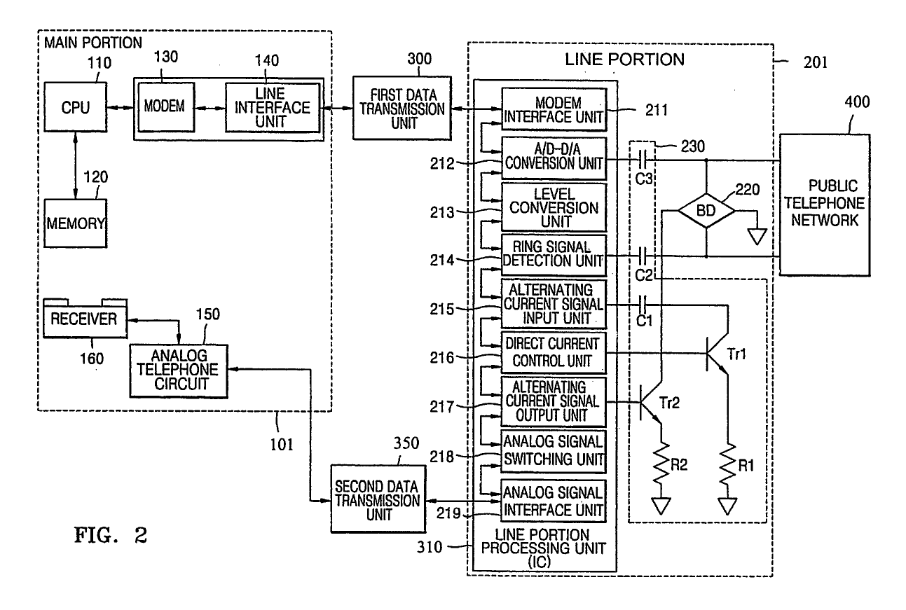

FIG. 2 is a block diagram showing a configuration of a telephone system in a multi-function product (MFP). The telephone system includes a main portion 100, a line portion 200, a first data transmission unit 300, a second data transmission unit 350, and a public telephone network 400.

The main portion 101 includes a central processing unit (CPU) 110, a memory 120, a modem 130, a line interface unit 140, an analog telephone circuit 150, and a receiver 160. The line portion 201 includes a line portion processing unit (IC) 310 which is equipped with a modem interface unit 211, an A/D-D/A conversion unit 212, a level conversion unit 213, a ring signal detection unit 214, an alternating current signal input unit 215, a direct current control unit 216, an alternating current signal output unit 217, an analog signal switching unit 218, an analog signal interface unit 219, a bridge diode 220, and a public telephone network connection unit 230.

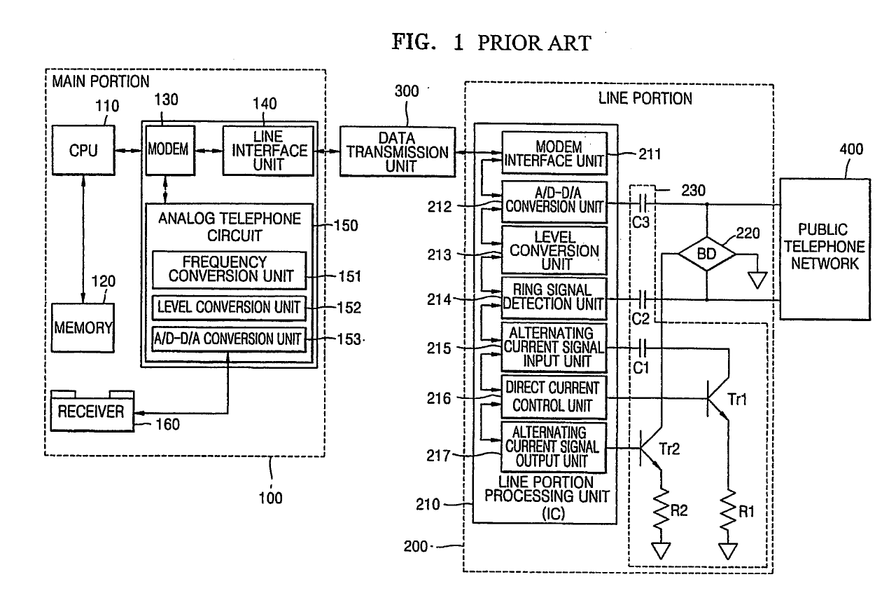

One of the differences between the conventional configuration shown in FIG. 1 and the configuration of an exemplary embodiment shown in FIG. 2 is the addition of the analog signal switching unit 218 and the analog signal interface unit 219 in the line portion processing unit (IC) 310 in order to connect an analog voice signal to the public telephone network 400 without converting the analog voice signal into a digital signal. Also, a second data transmission unit 350 is added in order to deliver an analog voice signal between the main portion 101 and line portion 201.

Operations of an exemplary embodiment of the telephone system of the present invention that are different from a conventional telephone system will be described.

The CPU 110 determines whether a user has taken the receiver off the hook or not after a ring signal and recognizes that the MFP is in a facsimile mode or in a telephone mode. When the user has taken the receiver 160 off the hook, the CPU 110 determines that the MFP is in the telephone mode, and when the user puts the receiver 160 on the hook, the CPU 10 determines that the MFP is in the facsimile mode.

When the MFP is in the telephone mode, a voice alternating current signal of a person on the other end of the line is input to the alternating current signal input unit 215 of the line portion processing unit (IC) 310 via the public telephone network connection unit 230.

In a telephone mode, the analog signal switching unit 218 switches an input analog voice signal output from the alternating current input unit 215 to output the input analog voice signal to the analog signal interface unit 219, and the analog signal interface unit 219 transmits the switched analog voice signal to the analog telephone circuit 150 via the second data transmission unit 350.

The analog telephone circuit 150 amplifies the analog voice signal input from the second data transmission unit 350, signal processes the analog voice signal according to characteristics of voice volume, and outputs the analog voice signal to the receiver 160. Therefore, a final user can hear a voice signal of a person on the other end of the line.

When the voice of the person on the other end of the line is delivered to the final user via the receiver 160, an analog voice output from the receiver 160 is input to the analog telephone circuit 150 to be signal processed. The signal processed analog voice signal is transmitted to the person on the other end of the line via the second data transmission unit 350, the analog signal interface unit 219, the analog signal switching unit 218, the public telephone network connection unit 230, and the public telephone network 400.

When the MFP is in the fax mode, a case of receiving a fax signal will be described. An analog fax signal input via the public telephone network 400 is converted into a digital fax signal in the A/D-D/A conversion unit 212 of the line portion processing unit (IC) 310. The digital fax signal having a contract form and is sent to the main portion 101 via the modem interface unit 211 and the first data transmission unit 300 to be stored in the memory 120 or to be printed.

Transmission of a fax signal when the MFP is in the fax mode will be described. An output signal generated in the modem 130 is converted into a digital data form by the line interface unit 140 and is delivered to the modem interface unit 211. The digital fax signal is converted into an analog fax signal again by the A/D-D/A conversion unit 212, and the alternating current signal output unit 217 transmits the analog fax signal to the public telephone network 400 via the public telephone network connection unit 230.

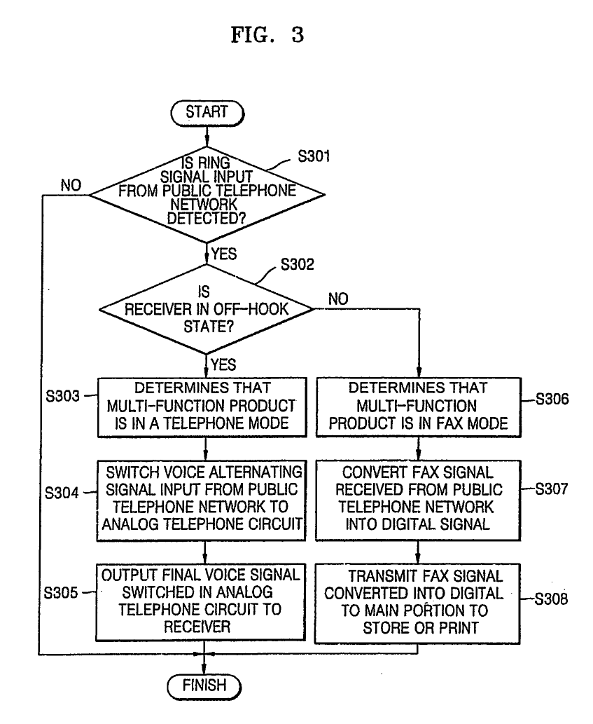

FIG. 3 is a flow chart showing an operating method of a telephone system of an MFP, according to an exemplary embodiment of the present invention.

Referring to FIGS. 2 and 3, the CPU 110 determines whether or not a ring signal is detected by the public telephone network 400 (operation S301).

The CPU 110 determines whether a user has taken the receiver 160 off the hook after detecting the ring signal (operation S302).

When the user has taken the receiver 160 off the hook, the CPU 110 determines that the MFP is in a telephone mode (operation S303).

When the MFP is in the telephone mode, a voice alternating current signal of a person on the other end of the line, which is input from the public telephone network 400, is input to the alternating current input unit 215 via the public telephone network connection unit 230. The analog signal switching unit 218 switches the input analog voice signal output from the alternating current signal input unit 215 to output to the analog signal interface unit 219. The analog signal interface unit 219 transmits the switched analog voice signal to the analog telephone circuit 150 via the second data transmission unit 350 (operation S304).

The analog telephone circuit 150 amplifies the analog voice signal input from the second data transmission unit 350, signal processes the analog voice signal according to the characteristics of the sound volume, and outputs the processed analog voice signal to the receiver 160. Therefore, a final user can hear the voice signal of the person on the other end of the line (operation S305).

When a voice alternating current signal is transmitted from the receiver 160 to the public telephone network 400, it performs the sequence described above in reverse order.

When the user puts the receiver 160 on the hook, the CPU 110 determines that the MFP is in a fax mode (operation S306).

When the MFP is in the fax mode, an analog fax signal input via the public telephone network 400 is converted into a digital fax signal in the A/D-D/A conversion unit 212 of the line portion processing unit (IC) 310 (operation S307).

To transmit the digital fax signal to the main portion 101, the digital fax signal gets to have a contract form to be sent to the main portion 101 via the modem interface unit 211 and the first data transmission unit 300 and is stored or printed (operation S308).

According to the present invention as described above, an MFP may be equipped with an analog telephone circuit to realize a telephone function such that an analog voice signal may be sent/received at a low price.

According to the present invention as described above, it is understood that the communication among the main portion 101, first data transmission unit 300, second data transmission unit 350, and line portion 310 may be wired or wireless.

The method of operating a telephone system in a multifunction product according to the present invention can be embodied as a computer program or set of instructions (computer program instructions). Code or code segments of the computer program can be provided by a computer programmer skilled in the art. The computer program may be stored in a computer readable medium or a plurality of computer readable media. The method can be realized by reading and executing the program with a computing device or other programmable apparatus in a multifunction product. The computing device may include a processor or a plurality of processors.

The method has been described with reference to examples and illustrations of methods according to exemplary embodiments of the invention. It will be understood that each block of the illustrations, and combinations of blocks in the illustrations, can be implemented by computer program instructions. These computer program instructions can be provided to a processor of a computing device of a multifunction product to produce a machine, such that the instructions, which execute via the processor of the computing device, implement the functions specified in the block or blocks. These computer program instructions may also be stored in a computer usable or computer-readable memory that can direct a computing device to function in a particular manner, such that the instructions stored in the computer-readable memory produce an article of manufacture to implement the function specified in the flowchart block or blocks. The computer program instructions may also be loaded onto a computing device to cause a series of operational steps to be performed on the computing device to produce a computer implemented process such that the instructions that execute on the computing device provide steps for implementing the functions specified in the flowchart block or blocks.

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in reverse order, depending on the functionality involved.

Examples of a computer-readable medium include a magnetic storage medium (e.g., a ROM, a floppy disk, or a hard disk), an optical storage medium (e.g., a CD-ROM or a DVD), and a carrier wave or digital transmission medium (e.g., data transmissions through the Internet).

Examples of the computer-readable medium further include any type of transmission medium including networks, which may be wired networks, wireless networks or any combination thereof. The computer-readable medium may be referred to as a medium, and the medium may be distributed among computing devices as part of one or more networks or coupled with one or more networks.

One or more computing devices may be part of a portable multifunction device, i.e., mobile nodes or terminals, enabling users to access a server or network such as the Internet. The mobile nodes or terminals may include laptop computers, web pads, hand-held PCs, personal digital assistants (PDAs), mobile phones, and so on.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A telephone system in a multi-function product, the system comprising:
a signal processing unit which receives ring signals, voice alternating current signals, and fax signals input from a public telephone network, digitally processes the received fax signals according to a control signal, transmits the received voice alternating current signal to a receiver, converts a fax signal to be sent into analog form, and transmits a voice alternating current signal to the public telephone network;
a telephone circuit which amplifies and signal processes the switched voice alternating current signal and then outputs the switched voice alternating current signal to a receiver or signal processes a voice signal input to the receiver and then outputs the voice signal to the signal processing unit; and
a control unit which determines whether the telephone system is in a telephone mode or a fax mode according to whether a receiver is on or off the hook and outputs a control signal to output the switched voice alternating current signal to the telephone circuit or a control signal to print and store the switched fax signal.

2. The system of claim 1, further comprising:
a first data transmission unit that sends/receives digital fax data between the signal processing unit and the control unit; and
a second data transmission unit that sends/receives a voice alternating current signal between the signal processing unit and the telephone circuit.

3. The system of claim 1, wherein:
when the receiver is in an off-hook state, the multi-function product is determined to be in a telephone mode and the control unit outputs a control signal to output the switched voice alternating current signal to the telephone circuit; and
when the receiver is in an on-hook state, the multi-function product is determined to be in a fax mode and the control unit outputs a control signal to print and store the signal processed fax signal.

4. A method of operating a telephone system in a multi-function product, comprising the operations of:
(a) determining whether a receiver is in an off-hook or on-hook state when a ring signal is sensed;
(b) determining whether a multi-function product is in a telephone mode or a fax mode according to whether the receiver is in the off-hook or on-hook state; and
(c) analog processing a voice alternating current signal input from the public telephone network in a telephone circuit and then outputting the analog processed voice alternating convert signal to the receiver, or digital processing a fax signal input from the public telephone network to print or store the fax signal, according to the determined mode of the multi-function product.

5. The method of claim 5, wherein:
when the receiver is in the off-hook state, the voice alternating current signal is analog processed and then output to the receiver after determining the multi-function product is in a telephone mode; and
when the receiver is in the on-hook state, the digital processed fax signal is printed or stored after determining the multi-function product is in a fax mode.

6. At least one computer readable medium for storing instructions that control at least one processor which executes a method of operating a telephone system in a multi-function product wherein the method comprises:
(a) determining whether a receiver is in an off-hook or on-hook state when a ring signal is sensed;
(b) determining whether a multi-function product is in a telephone mode or a fax mode according to whether the receiver is in the off-hook or on-hook state; and
(c) analog processing a voice alternating current signal input from the public telephone network in a telephone circuit and then outputting the analog processed voice alternating convert signal to the receiver, or digital processing a fax signal input from the public telephone network to print or store the fax signal, according to the determined mode of the multi-function product.

7. The medium of claim 6, wherein:
when the receiver is in the off-hook state, the voice alternating current signal is analog processed and then output to the receiver after determining the multi-function product is in a telephone mode; and
when the receiver is in the on-hook state, the digital processed fax signal is printed or stored after determining the multi-function product is in a fax mode.
